(19) United States
(12) Patent Application Publication
(10) Pub. No.: US 2026/0037822 A1
(43) Pub. Date: Feb. 5, 2026

(54) EFFICIENT TRAINING TECHNIQUES FOR GENERATIVE MODEL BASED RESPONSE SYSTEMS

(71) Applicant: GOOGLE LLC, Mountain View, CA (US)

(72) Inventors: Sanil Jain, Sunnyvale, CA (US); Mark Geller, Zurich (CH); Majd Al Merey, Zug (CH); Rakesh Shivanna, Sunnyvale, CA (US); Valentin Anklin, Zurich (CH); Ciprian Baetu, Zurich (CH); Martin Bölle, Zurich (CH); Hongkun Yu, Redwood City, CA (US); Han Lu, Redmond, WA (US)

(21) Appl. No.: 18/794,596

(22) Filed: Aug. 5, 2024

(51) Int. Cl. G06N 3/092; G06N 3/0475; G06N 3/0499; G06N 3/09

(52) U.S. Cl. CPC G06N 3/092; G06N 3/0475; G06N 3/0499; G06N 3/09

(57) ABSTRACT

Some implementations relate to receiving input data; generating, using a low-rank representation of a machine-learned generative model, a generative output from the input data; determining, based on a machine-learned reward model, a corresponding reward from the generative output, and updating, based on the corresponding reward, one or more parameters of the low-rank representation of the machine-learned model. Further, some additional or alternative implementations relate to receiving input data associated with a client device; generating, using a general purpose agent, responsive content to the input data, wherein the general purpose agent is configured based on a machine-learned generative model and a low-rank representation of the machine-learned generative model; and causing the client device to render the responsive content.

### BACKGROUND

Various generative models (GMs) have been proposed that can be used to process image content, audio content, natural language (NL) content and/or other input(s), to generate output that reflects generative content that is responsive to the input(s). As one example, stable diffusion models have been developed that can be used to process NL content and/or other input(s), to generate visual output that reflects NL content and/or other content that is responsive to the input(s). As another example, large language models (LLM(s)) have been developed that can be used to process NL content and/or other input(s), to generate LLM output that reflects NL content and/or other content that is responsive to the input(s).

GMs typically undergo a first phase of pre-training followed by a second phase of fine-tuning (or alternatively referred to as alignment, conditioning, etc.). Pre-training involves using large quantities of diverse data and can provide the GM with domain independent natural language reasoning capabilities. Following pre-training, the GM can undergo fine-tuning to improve the GM's ability to respond to user prompts and queries. Fine-tuning techniques can include, as examples, supervised fine-tuning (SFT) and reinforcement learning with human feedback (RLHF). However, a GM can include at least hundreds of millions of parameters, billions of parameters, hundreds of billions of parameters, or even more. As such, fine-tuning for GMs can be highly computationally expensive.

Techniques such as low-rank training in the fine-tuning phase have been proposed to mitigate some of these problems. However, such techniques can result in trained models which are limited to a single, or a small number, of domains, at least in part because they typically rely on SFT techniques with relatively small (human) labeled training datasets which may be limited to a small number of domains or task types.

### SUMMARY

Implementations disclosed herein are directed to reducing the computational expenditure of fine-tuning a generative model (GM) whilst also maintaining general purpose capabilities of the resulting GM. More specifically, implementations disclosed herein utilize a low rank representation of a pre-trained GM to reduce the number of parameters to be trained during the fine-tuning phase. By reducing the number of parameters to be trained, computational resource expenditure (such as memory usage and processing power usage) for training can be reduced since each training cycle consumes fewer resources. For instance, the techniques described herein have been evaluated to reduce the trainable parameters by around 50 times, as well as improving training speed at each training stage, namely an improvement of around 80% in training speed in the SFT phase, and an improvement of around 20% in the reinforcement learning phase has been found. In addition, implementations described herein can result in general purpose capabilities of the resulting GM to be maintained by various training techniques and/or model architecture(s) described herein. For instance, various implementations described herein enable low rank training to be performed with reinforcement learning. Furthermore, in some implementations, a “decoupled” reward model is utilized, and in some implementations, the parameters of the low-rank representation correspond to feed-forward network weights of the GM.

Various implementations described herein relate to providing a general purpose agent, or in other words, a GM based response system which maintains general purpose capabilities. A general purpose agent can be considered “general purpose” by being capable of generating responses across a plurality of different domains (or in other words, GM tasks). For instance, a domain can relate to a specific type of task for which the pre-trained GM and/or the low-rank representation of the pre-trained GM is trained e.g., based on training data that is associated with the specific type of task. As one example, a domain can relate to robot control command generation tasks, whereby a model which is capable of generating responses in this domain can be trained based on training data that is associated with robot control and/or performance data. As another example, a domain can relate to medical tasks, whereby a model which is capable of generating responses in this domain can be trained based on training data that is associated with medical data. It is noted that these are merely examples, which are not limiting, and that a general purpose agent can operate across any number of different domains and tasks.

As described herein, a low-rank representation of a pre-trained GM can be trained using reinforcement learning utilizing a decoupled reward model. The reward model can be considered to be “decoupled” by virtue of being initialized based on the pre-trained GM and/or trained using the pre-trained GM (e.g., rather than a fine-tuned (or e.g., SFT) GM or low-rank representation of a GM). In this way, the trained low-rank representation can retain general purpose capabilities and can be utilized by a general purpose agent. This can be at least in part because the pre-trained GM will typically have been trained on diverse training data, whereas the training data used for the fine-tuning (or e.g., SFT) may be relatively less diverse, for instance, relating to a limited number of domains (e.g., a single domain). Furthermore, utilizing a “decoupled” reward model can provide more stable training. For instance, since the reward model is initialized based on the pre-trained GM and/or trained using the pre-trained GM, and the pre-trained GM will have its parameters frozen after pre-training, the reward model need not be further updated as the low-rank representation is fine-tuned. By comparison, if the reward model was based on a fine-tuned (e.g., SFT) model, a new reward model would need to be determined each time the fine-tuned model is updated (which may occur relatively more often than pre-training, as well as for different users, different domains, etc.). As a result, the training process is simplified without impacting the quality of the resulting GM.

Moreover, various implementations described herein can reduce the resource expenditure in developing and testing generative model architectures and training techniques. This can be at least in part because of the utilization of low-rank training, as well as from the improved stability of the training of the reward model (e.g., since the reward model need not be re-generated as often).

In some implementations, a GM can be an image generation model, an audio generation model or a large language model (LLM). In some additional or alternative implementations, a GM is a sequence-to-sequence model, is Transformer-based, can include an encoder and/or a decoder, and/or can include an attention mechanism or other form of memory. One non-limiting example of a GM is GOOGLE'S Pathways Language Model (PaLM). Another non-limiting example of a GM is GOOGLE'S Language Model for Dialogue Applications (LaMDA). Another non-limiting example of a GM is GOOGLE'S Gemini. However, and as noted, it should be noted that the GMs described herein are examples of generative machine learning models, and are not intended to be limiting.

The preceding is presented as an overview of only some implementations disclosed herein. These and other implementations are disclosed in additional detail herein.

### BRIEF DESCRIPTION OF THE DRAWINGS

FIG. 1 depicts a block diagram of an example environment that demonstrates various aspects of the present disclosure, and in which some implementations disclosed herein can be implemented.

FIG. 2 depicts an overview of an example method for providing a general purpose agent, according to various implementations.

FIG. 3A and FIG. 3B depict flowcharts that illustrate example methods for providing a decoupled reward model, according to various implementations.

FIG. 4A, FIG. 4B, and FIG. 4C depict flowcharts that illustrate example methods for fine-tuning a low-rank representation of a pre-trained GM, according to various implementations.

FIG. 5 depicts a flowchart that illustrates an example method for providing a low-rank representation of a pre-trained GM, according to various implementations.

FIG. 6 depicts a flowchart that illustrates an example method for training a low-rank representation of a pre-trained GM, according to various implementations.

FIG. 7 depicts a flowchart that illustrates an example method for providing responsive content using a general purpose agent, according to various implementations.

FIG. 8 depicts an example architecture of a computing device, in accordance with various implementations.

### DETAILED DESCRIPTION

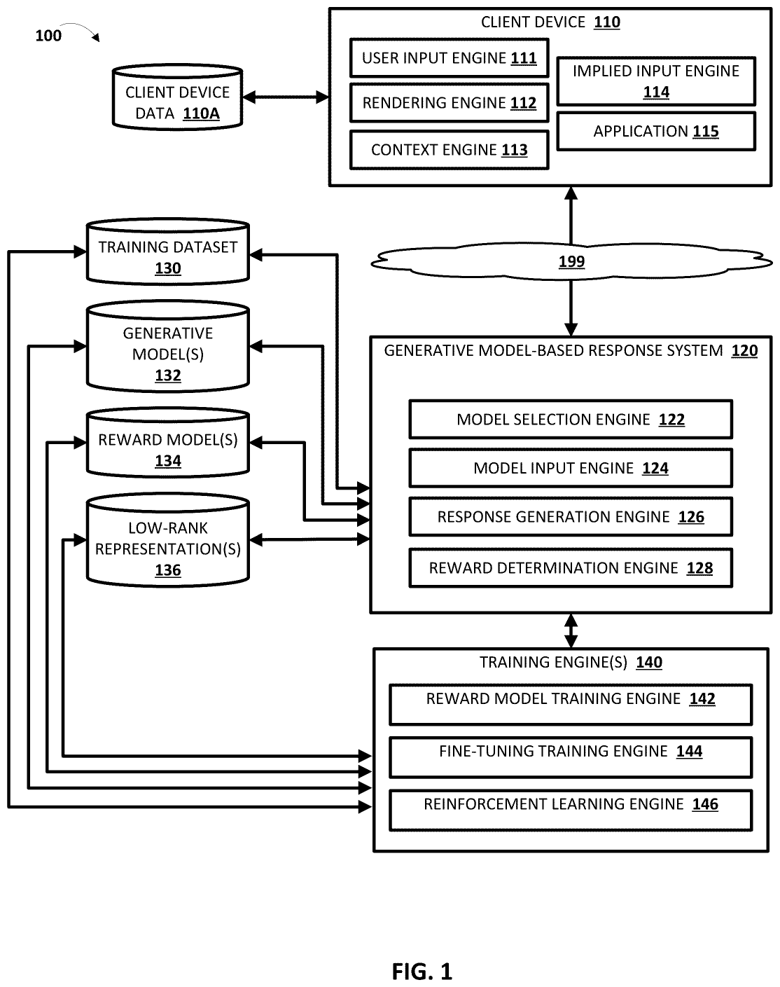

Turning now to FIG. 1, a block diagram of an example environment 100 that demonstrates various aspects of the present disclosure, and in which implementations disclosed herein can be implemented is depicted. The example environment 100 includes a client device 110, a generative model-based response system 120, and training engine(s) 140. Although illustrated separately, in some implementations all or aspects of generative model-based response system 120 and all or aspects of the training engine(s) 140 can be implemented as part of a cohesive system.

In some implementations, all or aspects of the generative model-based response system 120 can be implemented locally at the client device 110. In additional or alternative implementations, all or aspects of the generative model-based response system 120 can be implemented remotely from the client device 110 as depicted in FIG. 1 (e.g., at remote server(s)). In those implementations, the client device 110 and the generative model-based response system 120 can be communicatively coupled with each other via one or more networks 199, such as one or more wired or wireless local area networks (“LANs,” including Wi-Fi LANs, mesh networks, Bluetooth, near-field communication, etc.) or wide area networks (“WANs”, including the Internet).

The client device 110 can be, for example, one or more of: a desktop computer, a laptop computer, a tablet, a mobile phone, a computing device of a vehicle (e.g., an in-vehicle communications system, an in-vehicle entertainment system, an in-vehicle navigation system), a standalone interactive speaker (optionally having a display), a smart appliance such as a smart television, and/or a wearable apparatus of the user that includes a computing device (e.g., a watch of the user having a computing device, glasses of the user having a computing device, a virtual or augmented reality computing device). Additional and/or alternative client devices may be provided.

The client device 110 can execute one or more applications, such as application 115, via which input data can be provided and/or selected, and/or other response(s) to the input data can be rendered (e.g., audibly and/or visually). The application 115 can be an application that is separate from an operating system of the client device 110 (e.g., one installed “on top” of the operating system)—or can alternatively be implemented directly by the operating system of the client device 110. For example, the application 115 can be a web browser installed on top of the operating system, or can be an application that is integrated as part of the operating system functionality. The application 115 can interact with the generative model-based response system 120.

In various implementations, the client device 110 can include a user input engine 111 that is configured to detect user input provided by a user of the client device 110 using one or more user interface input devices. For example, the client device 110 can be equipped with one or more microphones that capture audio data, such as audio data corresponding to spoken utterances of the user or other sounds in an environment of the client device 110. Additionally, or alternatively, the client device 110 can be equipped with one or more vision components that are configured to capture vision data corresponding to images and/or movements (e.g., gestures) detected in a field of view of one or more of the vision components. Additionally, or alternatively, the client device 110 can be equipped with one or more touch sensitive components (e.g., a keyboard and mouse, a stylus, a touch screen, a touch panel, one or more hardware buttons, etc.) that are configured to capture signal(s) corresponding to touch input directed to the client device 110. Some instances of input data described herein can be input data that is formulated based on user input provided by a user of the client device 110 and detected via user input engine 111. For example, a query can be typed via a physical or virtual keyboard, a suggested query that is selected via a touch screen or a mouse, a spoken voice query that is detected via microphone(s) of the client device, or an image query that is based on an image captured by a vision component of the client device or an image stored in a memory of the client device.

In various implementations, the client device 110 can include a rendering engine 112 that is configured to provide content (e.g., generative content) for audible and/or visual presentation to a user of the client device 110 using one or more user interface output devices. For example, the client device 110 can be equipped with one or more speakers that enable content to be provided for audible presentation to the user via the client device 110. Additionally, or alternatively, the client device 110 can be equipped with a display or projector that enables content to be provided for visual presentation to the user via the client device 110.

In various implementations, the client device 110 can include a context engine 113 that is configured to determine a context (e.g., current or recent context) of the client device 110 and/or of a user of the client device 110. In some of those implementations, the context engine 113 can determine a context utilizing current or recent interaction(s) via the client device 110, a location of the client device 110, profile data of a profile of a user of the client device 110 (e.g., an active user when multiple profiles are associated with the client device 110), and/or other data accessible to the context engine 113. For example, the context engine 113 can determine a current context based on a current state of a query session (e.g., considering one or more recent queries of the query session), profile data, and/or a current location of the client device 110. For instance, the context engine 113 can determine a current context of “looking for a healthy lunch restaurant in Louisville, Kentucky” based on a recently issued query, profile data, and a location of the client device 110. As another example, the context engine 113 can determine a current context based on which application is active in the foreground of the client device 110, a current or recent state of the active application, and/or content currently or recently rendered by the active application. A context determined by the context engine 113 can be utilized, for example, in supplementing or rewriting a query that is formulated based on user input, in generating an implied query (e.g., a query formulated independent of user input), and/or in determining to submit an implied query and/or to render result(s) (e.g., an NL based summary) for an implied query.

In various implementations, the client device 110 can include an implied input engine 114 that is configured to: generate an implied query independent of any user input directed to formulating the implied query; to submit an implied query, optionally independent of any user input that requests submission of the implied query; and/or to cause rendering of result(s) for an implied query, optionally independent of any user input that requests rendering of the result(s)). For example, the implied input engine 114 can use current context, from context engine 113, in generating an implied query, determining to submit the implied query, and/or in determining to cause rendering of result(s) for the implied query. For instance, the implied input engine 114 can automatically generate and automatically submit an implied query based on the current context. Further, the implied input engine 114 can automatically push result(s) to the implied query to cause them to be automatically rendered or can automatically push a notification of the result(s), such as a selectable notification that, when selected, causes rendering of the result(s). As another example, the implied input engine 114 can generate an implied query based on profile data (e.g., an implied query related to an interest of a user), submit the query at regular or non-regular intervals, and cause corresponding result(s) for the submission(s) to be automatically provided (or a notification thereof automatically provided).

Further, the client device 110 and/or the generative model-based response system 120 can include one or more memories for storage of data and/or software applications, one or more processors for accessing data and executing the software applications, and/or other components that facilitate communication over one or more of the networks 199. In some implementations, one or more of the software applications can be installed locally at the client device 110, whereas in other implementations one or more of the software applications can be hosted remotely (e.g., by one or more servers) and can be accessible by the client device 110 over one or more of the networks 199.

Although aspects of FIG. 1 are illustrated or described with respect to a single client device having a single user, it should be understood that is for the sake of example and is not meant to be limiting. For example, one or more additional client devices of a user and/or of additional user(s) can also implement the techniques described herein. For instance, the client device 110, the one or more additional client devices, and/or any other computing devices of a user can form an ecosystem of devices that can employ techniques described herein. These additional client devices and/or computing devices may be in communication with the client device 110 (e.g., over the network(s) 199). As another example, a given client device can be utilized by multiple users in a shared setting (e.g., a group of users, a household).

The generative model-based response system 120 is illustrated as including a model selection engine 122, a model input engine 124, a response generation engine 126, and a reward generation engine 128. Some of the engines can be omitted in various implementations. In some implementations, the engines of the generative model-based response system 120 are distributed across one or more computing systems.

The model selection engine 122 can, in response to receiving a query or other input, determine which, if any, of multiple generative model(s) 132 (e.g., LLM(s), image generation models, audio generation models, multi-modal generation models, and/or other generative model(s)), and which, if any of corresponding low-rank representation(s) 136 to utilize in generating response(s) to render responsive to the query/input. For example, the model selection engine 122 can select none, one, or multiple generative model(s) and none, one, or multiple corresponding low-rank representation(s) to utilize in generating response(s) to render responsive to a query/input. The model selection engine 122 can optionally utilize one or more classifiers and/or rules (not illustrated).

The model input engine 124 can, in response to receiving a query/input data, generate model input that is to be processed using a generative model in generating a response to the query/input data. As described herein, such content can include query content that is based on the query and/or additional content, such as contextual information. The model input engine can, for example, reformat input data into a suitable form for input into a generative model, e.g., reformat an input NL query as a prompt for an LLM, reformat one or more input images into a tensor for input into an image generation model or the like.

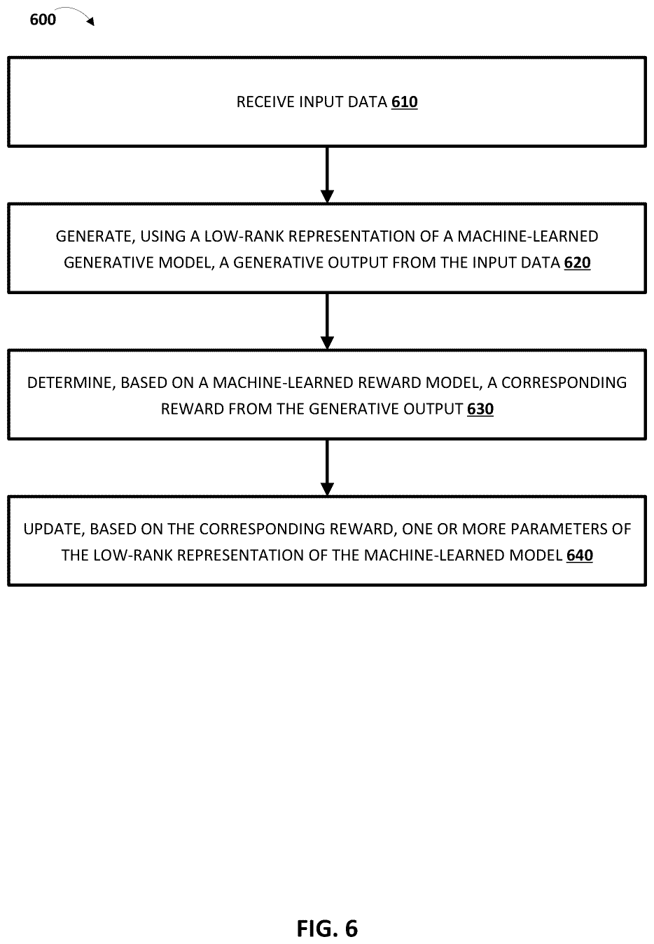

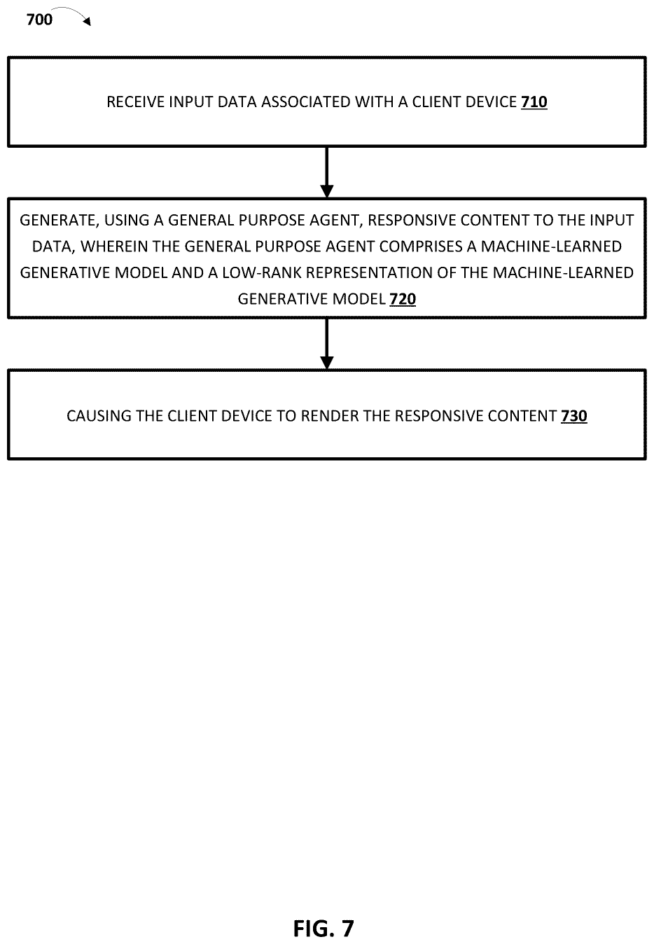

The response generation engine 126 can process input data that is generated by the model input engine 124 (e.g., using a generative model and/or a low-rank representation) to generate response/output data. The response generation engine 126 can generate a one or more candidate responses from the input data/query using one or more generative models 134, e.g., LLMs, image generation models, audio generation models, multi-modal generation models, or the like, as well as corresponding low-rank representation(s) 136. Generating the one or more generative outputs from a respective set of input data (e.g., using a low-rank representation (and optionally also a machine-learned GM, as described herein), a machine-learned GM, and/or a general purpose agent) can include generating one or more distributions over a set of potential generative outputs. Each generative output may be generated by sampling from this distribution, e.g., each generative output may correspond to a different decoding of a probability distribution generated using the respective model. In some implementations, a response selection engine (not shown) can select one or more of the candidate responses generated by the response generation engine 126 for presentation to the user, e.g., via the rendering engine 112 and/or application 115 of the client device 110. In some implementations, the response selection engine may utilize one or more reward models 134 to select the one or more of the candidate responses for presentation to the user, e.g., by utilizing the output of the reward determination engine 128. In various implementations, response generation engine 126 can perform all or aspects of block 620 of FIG. 6, and/or block 720 of FIG. 7.

The reward determination engine 128 can utilize one or more reward models 134 (also referred to as “preference models”) to determine rewards for the candidate generative outputs generated by the response generation engine 126. The one or more reward models 134 may include one or more pointwise reward models, i.e., reward models that take a candidate generative output as input and generate a score for said candidate generative output indicative of how preferred the candidate output is as a response to the input data/query. The one or more reward models 134 may include one or more pairwise reward models, i.e., reward models that take a pair of candidate generative outputs as input and generate a score for said pair of candidate generative output indicative of how likely one candidate input of the pair is to be preferred over the other candidate input of the pair as a response to the input data/query. In various implementations, the reward determination model can perform all or aspects of block 630 of FIG. 6.

The training engine(s) 140 is illustrated as including one or more reward model training engines 142, one or more fine-tuning training engines 144, and one or more reinforcement learning engines 146. Some of the engines can be omitted in various implementations.

The one or more reward model training engines 142 can utilize labeled/preference training data, e.g., human labeled/preference data or synthetic labeled/preference data, to train and/or evaluate the one or more reward models 134. For example, the one or more reward model training engines 142 can use training data from a training dataset to retrain/fine-tune parameters of one or more of the reward models 134. Alternatively, or additionally, the one or more reward model training engines 142 can use evaluation data from an evaluation dataset to evaluate the performance of one or more of the reward models 134.

The one or more fine-tuning training engines 144 can utilize training data to train the one or more low-rank representation(s) 136. For example, the one or more fine-tuning training engines 144 can use training data from a training dataset to retrain/fine-tune parameters of one or more of the low-rank representations 136. The one or more fine-tuning training engines 144 may utilize supervised fine-tuning (SFT) techniques to train the one or more low-rank representations 136.

The one or more reinforcement learning engines 146 can utilize training data and one or more reward models 134 to train and/or evaluate the one or more low-rank representations 136. For example, the one or more reinforcement learning engines 146 can use training data from a training dataset and one or more reward models 134 to retrain/fine-tune parameters of one or more of the low-rank representations 136. The one or more reinforcement learning engines 146 may utilize reinforcement learning techniques to train the one or more low-rank representations 136, using one or more reward models 134 to provide a reward for the reinforcement learning.

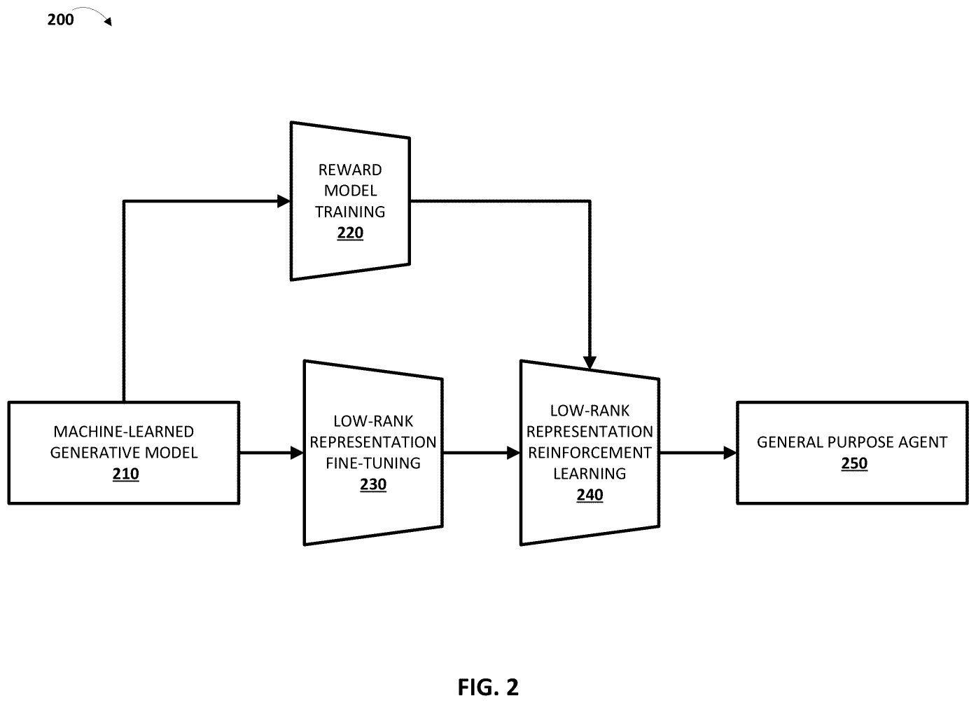

Turning now to FIG. 2, an overview of an example method 200 for providing a general purpose agent 250, according to various implementations, is depicted.

As illustrated in FIG. 2, a machine-learned (or in other words, pre-trained) GM 210 is obtained. In some implementations, the machine-learned GM 210 has already been pre-trained, and is retrieved, for instance, from one or more machine-learned GMs (e.g., the GM(s) 132 of FIG. 1) from local or remote storage. Additionally, or alternatively, in some implementations, the machine-learned GM 210 can be generated based on pre-training (or further pre-training) a GM retrieved from local or remote storage. The GM can be pre-trained on large amounts of data including data from, but not limited to, webpages, electronic books, software code, electronic news articles, and machine translation data. The GM can be pre-trained using unsupervised or self-supervised learning. For example, the GM can be pre-trained on a next token prediction task and/or a masked token prediction task. The parameters of the machine-learned GM 210 can be frozen for subsequent processing. In this way, the capabilities of the machine-learned GM 210 (including the general purpose capabilities, or in other words, multi-domain capabilities, of the machine-learned GM 210) will not be “forgotten” as a result of further training or fine-tuning.

The machine-learned GM 210 may, in some implementations, be a neural network model. For example, the machine-learned GM 210 may include one or more of: a convolutional neural network; a variational autoencoder; a recurrent neural network (RNN), such as a long short-term memory (LSTM) network; a transformer-based network; or the like. The machine-learned GM 210 may be a generative model trained using generative-adversarial techniques, such as a conditional GAN (cGAN). The machine-learned GM 210 may be a stable diffusion model. Many other examples are possible.

The machine-learned GM 210, in some examples, generates a probability distribution over a set of outputs, e.g., a probability distribution over a set of pixel values, phonemes and/or tokens. The probability distribution may be a conditional probability distribution. The probability distribution can be sampled to generate one or more candidate generative outputs.

In some implementations, the machine-learned GM 210 is an image generation model configured to generate images from a set of input data. The input data for such image generation models may include a natural language description of a desired output image, e.g., “draw me a picture of a cat”. The machine-learned GM 210 may generate one or more images conditioned on the input natural language description, e.g., one or more images of a cat in this example. Alternatively, or additionally, the input data may include one or more images that are used to condition the generation of the output images. In some implementations, the input data 204 may include a content image indicating a desired content for a generated image and a style image indicating a desired style for a generated image. For example, the content image may be an image of a cat, and the style image may be an image in an impressionistic style, which guides the generative model to generate images of cats in an impressionistic style.

In some implementations, the machine-learned GM 210 is an audio generative model configured to generate audio samples from a set of input data. The input data may include text data, e.g., text data representing a description of a desired audio output, and/or content of the desired output. The input data may include audio data, e.g., audio data representing a desired audio output style and/or content. The machine-learned GM 210 may generate a plurality of audio samples conditioned on the input data.

In some implementations, the machine-learned GM 210 is a large language model (LLM) configured to generate a sequence of text tokens from a set of input data. The input data includes a natural language prompt, e.g., a sequence of text tokens. The prompt may be a query or request for the LLM to provide some information, or to perform a function. For example, the input prompt may include the text “Can you summarize the plot to the play Hamlet”. Based on this prompt the LLM generates a plurality of textual summaries of the play Hamlet.

In some implementations, the machine-learned GM 210 is a multi-modal generative model configured to generate output data in a plurality of modalities and/or receive input data in a plurality of modalities.

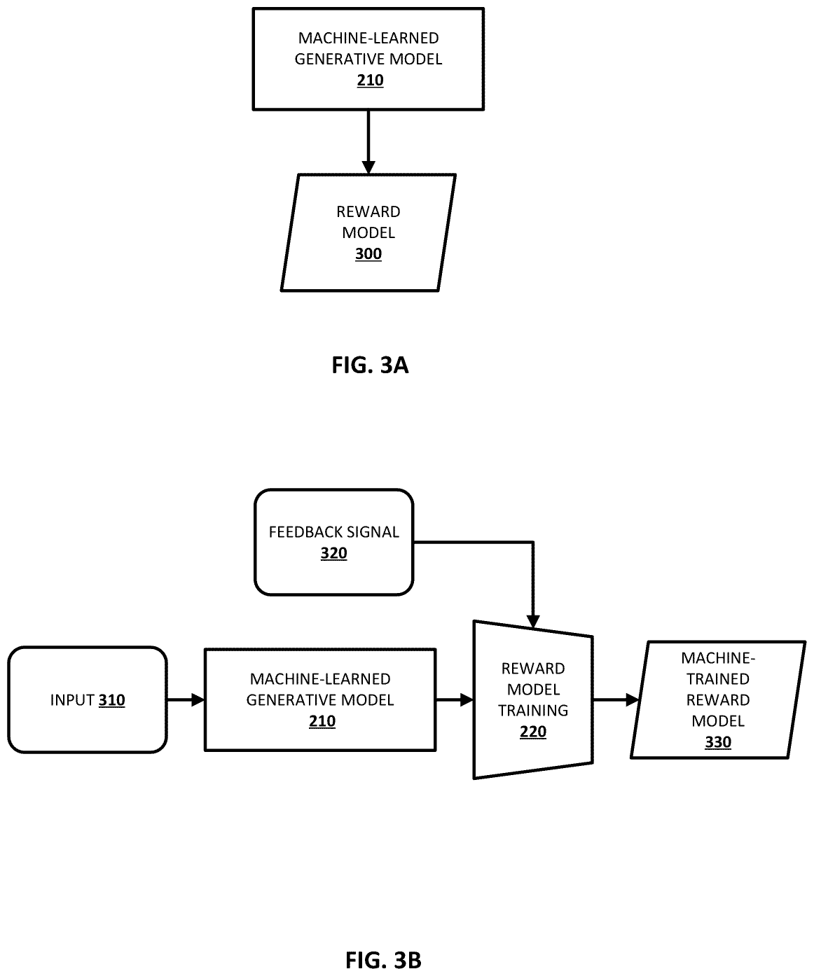

As further illustrated in FIG. 2 by reward model training 220 phase, a “decoupled” reward model can be initialized and/or trained using the machine-learned GM 210. This aspect is described in further detail herein, particularly in relation to FIGS. 3A and 3B.

For instance, turning briefly to FIG. 3A, a flowchart that illustrates an example method for providing a decoupled reward model, according to various implementations, is depicted.

As illustrated in FIG. 3A, the reward model 300 can be determined (or in other words, initialized, generated, created, etc.) based on the machine-learned GM 210. For instance, the reward model can have the same or similar architecture to that of the machine-learned GM 210, and/or include some or all of the parameters of the machine-learned GM 210. Furthermore, an additional head for generating a scalar value (e.g., a scalar preference value, or a “reward” value) for a particular input and generated output pair can be added (e.g., replacing one or more final layers of the machine-learned GM 210).

Turning briefly to FIG. 3B, a flowchart that illustrates an example method for providing a decoupled reward model 300, according to various implementations, is depicted.

In some implementations, the reward model 300 can be obtained, for instance, according to the method described in relation to FIG. 3A. In some implementations, the reward model 300 can be obtained from one or more reward model(s) available locally and/or remotely.

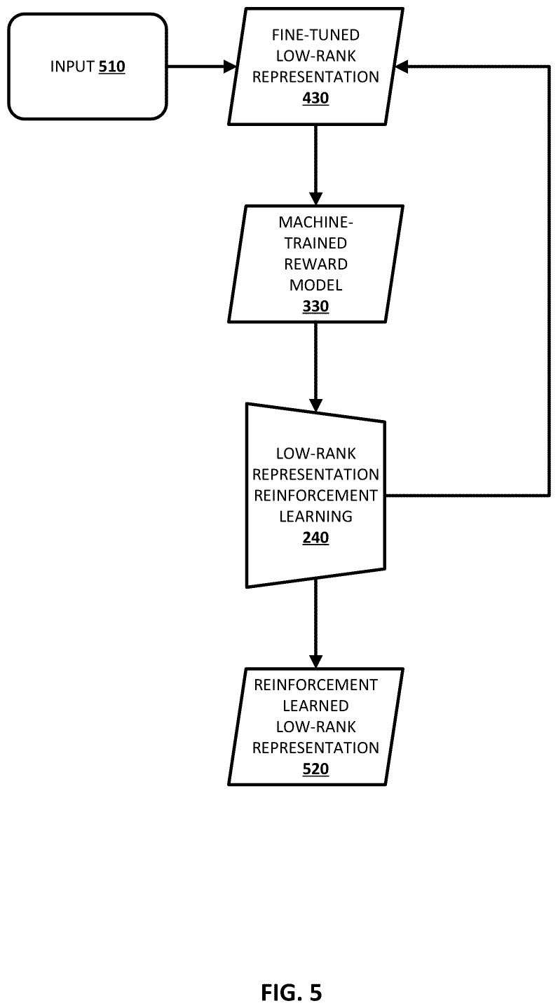

As illustrated in FIG. 3B, the reward model 300 can be trained utilizing the machine-learned GM 210. Training the reward model 300 can include any suitable training framework, such as reinforcement learning from human feedback (RLHF). For instance, in RLHF, the reward model 300 can be trained from feedback signals 320 including human preference data regarding different outputs generated from the same input prompt. That is, given an input prompt 310, one or more generative outputs can be generated using the machine-learned generative model 210, as well as any number of other models. More specifically, the spaces of generative model inputs 310 and outputs can be denoted by X and Y respectively, with π: X→Y denoting the action of the machine-learned generative model 210. The input prompt 310 and the one or more generative outputs can then be shown to human assessors, and the human assessors can be asked to score the outputs with respect to the input prompt 310, rank the outputs in order of preference with respect to the input prompt 310, provide a thumbs up/thumbs down indication with respect to the input prompt 310, etc. As an example, in some implementations, human preference data can be collected in the form of pairwise preferences between two candidate responses, (y₊, y₋)∈Y² to a given query, q∈X. The preference of y₊ over y₋ can thus be denoted y₃₀ [symbol] y₋. This can be repeated with many different input prompts 310 to generate a human labeled dataset of preference data, which can be denoted as D_{HF}={(q, y₊, y₋), y₊ [symbol] y₋}). A reward model 300 can then be trained on this preference data to provide a scalar preference value (e.g., a “reward” value) for a particular input prompt and generated output pair, or in other words, to predict reward data for outputs of the machine learned GM 210. The trained reward model 330 may then be leveraged to improve generation quality of the low-rank representation of the machine learned GM 210, e.g., through reinforcement learning, e.g., by aligning the low-rank representation of the machine learned GM 210 to the labeled data, as described in more detail in relation to FIG. 5.

In some examples, the machine-trained reward model 330 takes as input a single generative output from the low-rank representation of the machine learned GM 210 and outputs a score (i.e., a reward) indicative of how aligned the output is with the human labeled data that the machine-trained reward model 330 has been trained on. Such a reward model 330 may be referred to as a “pointwise reward model”, and denoted r_{θ}, where θ denotes parameters of the machine-trained reward model 330, and corresponds to a map r: X×Y→R. In some examples, the machine-trained reward model 330 is based on the Bradley-Terry model under which pairwise preferences between generative outputs are assumed to be determined from the pointwise model, r, using:

$${P}_{θ} ( q ) = \frac{expexp ( r ( q , {y}_{+} ) )}{expexp ( r ( q , {y}_{+} ) ) + expexp ( r ( q , {y}_{-} ) )} .$$

For instance, in some implementations, parameters of the machine-trained reward model 330 may be estimated from the human labeled dataset using a maximum likelihood method applied to a loss function. For example, the maximum likelihood of the following loss function can be estimated to determine the parameters of the reward model:

$${E}_{( q , {y}_{+} , {y}_{-} ) ∼ {D}_{H F}} [ log log ( σ ( r ( q , {y}_{+} ) - r ( q , {y}_{-} ) ) ) ]$$

where σ is the sigmoid function.

In some examples, the machine-trained reward model 330 may take as input a pair of generative outputs from the low-rank representation of the machine learned GM 210 and output data (e.g., a reward) indicative of a probability that one of the generative outputs of the pair is preferred over the other given the input to the generative network. For example, the output of the machine-trained reward model 330 may be denoted by P_{θ}(yᵢ [symbol] yⱼ|q), where θ represents the parameters of the machine-trained reward model 330, P, yᵢ∈Y is a first generative output of the pair of generative outputs, yⱼ∈Y is a second generative output of the pair of generative outputs, and q is the input to the low-rank representation of the machine learned GM 210. Such a reward model 330 may be referred to as a “pairwise reward model”.

Although the reward model training 220 has generally been described in relation to a RLHF framework, this is not intended to be limiting, and any suitable reward model training framework may be additionally or alternatively utilized. For instance, in some implementations, reward model training 220 can include training based on an RLAI framework. In some additional or alternative implementations, other feedback signals 320 can be utilized, such as one or more properties of the generative output(s) (e.g., length of response). In some additional or alternative implementations, the reward model 300 can be updated/fine-tuned using a self-supervision approach.

In this way, by initializing and/or training the reward model 300 based on the machine-learned generative model 210, which has been pre-trained based on diverse training data and then had its parameters frozen (e.g., rather than a fine-tuned GM or a low-rank representation thereof, which may have been fine-tuned (e.g., SFT) based on relatively limited training data (e.g., limited to a single task or domain)) the machine-trained reward model 330 can be utilized in reinforcement learning without risk of the loss of general purpose/multi-domain capabilities.

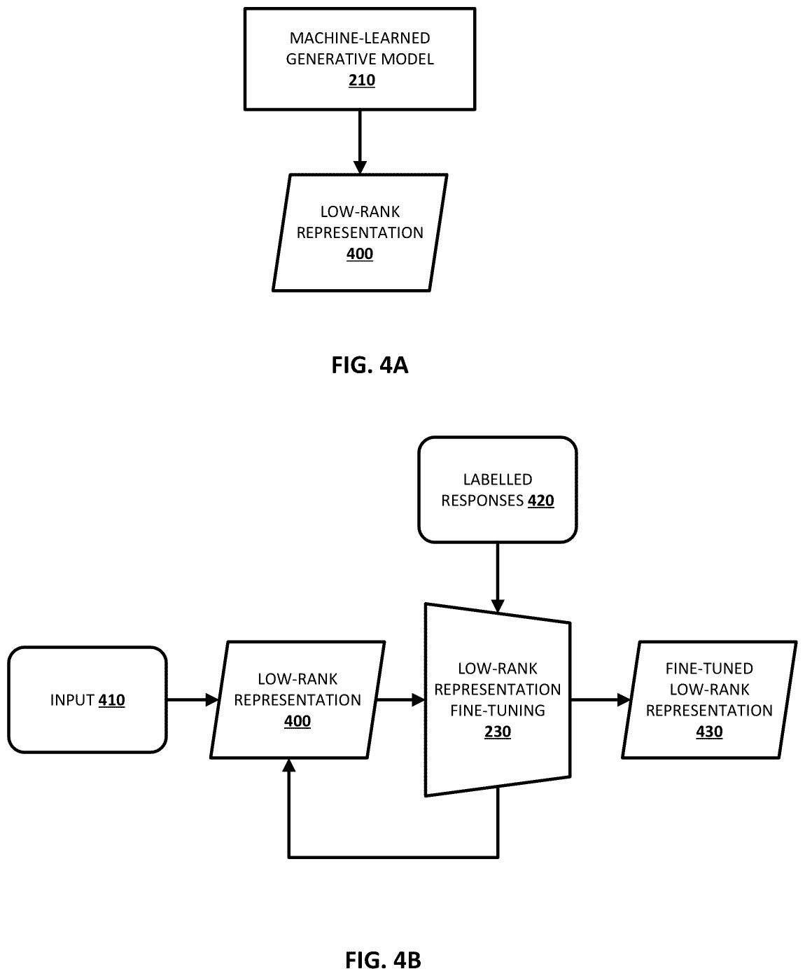

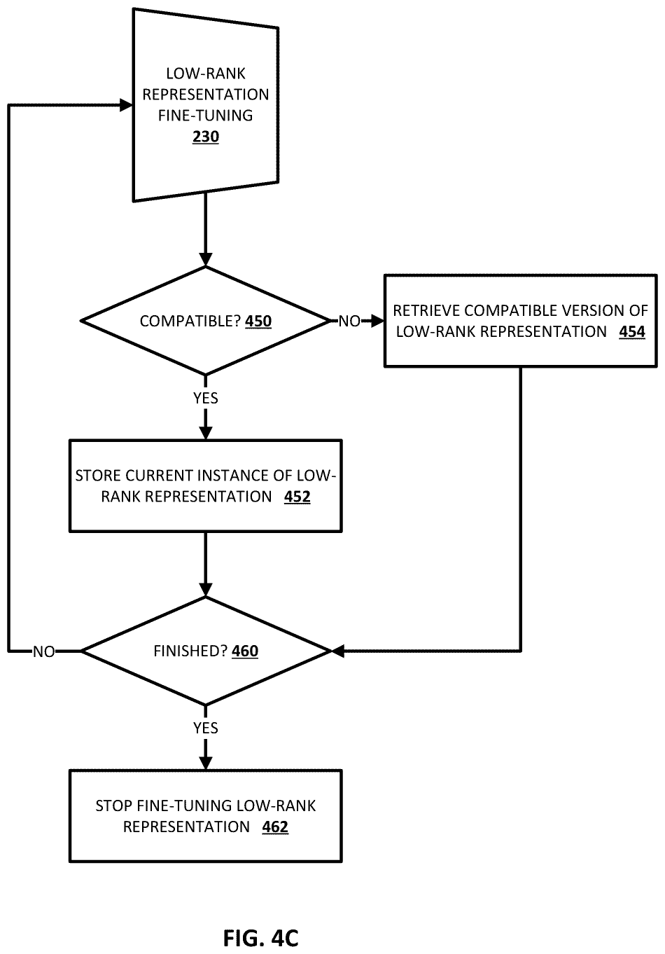

Turning now back to FIG. 2, as further illustrated in FIG. 2 by the low-rank representation fine-tuning 230 phase, a low-rank representation of the machine learned generative model 210 can be determined and fine-tuned. This aspect is described in further detail herein, particularly in relation to FIGS. 4A, 4B, and 4C.

For instance, turning briefly to FIG. 4A, a flowchart that illustrates an example method for determining a low-rank representation of a pre-trained GM, according to various implementations, is depicted.

As illustrated in FIG. 4A, a low-rank representation 400 of the machine-learned GM 210 can be determined based on reducing one or more (relatively) large matrices of the machine-learned GM into one or more (relatively) small matrices. For instance, this can be achieved by decomposing (or alternatively termed, transforming) model parameters of the machine-learned GM 210 into a lower-rank dimension. The resulting low-rank representation 400 can thus include significantly less parameters than the machine-learned GM 210 on which it is based, and thus further training (e.g., fine-tuning, alignment, etc.) will be much less computationally expensive as a result. This is based on the principle that updates to the machine-learned GM 210 during fine tuning will include various redundancies (or in other words, they may have a small “intrinsic rank”), and thus further training all of the parameters of the machine-learned GM 210 will result in computational resources being consumed in determining parameter updates which provide negligible (or zero) performance increase. As such, the low-rank representation 400 can be determined based on the principle of reducing these redundancies. For instance, assuming that the machine-learned GM 210 includes the weights W0 with dimensions d×k, the accumulated updates to the weights during fine-tuning is ΔW with dimensions d×k, and the resulting fine-tuned weights are W with the dimensions d×k, the low rank representation of the weights W0 of the machine learned GM 210 can be determined to include the matrices A with dimensions r×k and B with dimensions d×r, where r is a “low” rank (e.g., much smaller than either one of d or k), and where:

$$W = W 0 + Δ W = W 0 + B A .$$

In some implementations, at least some of the parameters of the low-rank representation correspond to weights of a self-attention layer of the machine learned GM 210. However, the weights of the self-attention layer can be strongly associated with specific domains or tasks. As such, in some implementations, at least some of the parameters of the low-rank representation correspond to feed-forward network weights (otherwise termed multi-layer perceptron (MLP) weights) of the machine-learned GM 210. In other words, following the example above, the matrix W0 can correspond to feed-forward network weights of the machine-learned GM 210, the matrix ΔW can correspond to accumulated updates to the feed-forward network weights of the machine-learned GM 210, and the matrix W can correspond to the resulting fine-tuned feed-forward network weights of the machine-learned GM 210. In this way, general purpose/multi domain capabilities can be retained during training of the low-rank representation 400 (as described herein), and the training of the low-rank representation 400 can be robust to using training data across multiple (and often conflicting) domains. Additionally, this enables the training of the low-rank representation 400 (as described herein) to focus on learning representations based on which general purpose/multi domain capabilities can be adapted rather than learning knowledge as with self-attention layers.

In some implementations, the low-rank representation 400 can be referred to as a low-rank adapter, a low-rank approximation, one or more low-rank matrices, etc. Furthermore, in some implementations, the low-rank representation 400 can be implemented as, for instance, a low-rank adaptation (LoRA) adapter, a quantized low-rank adaptation (QLoRA) adapter, a quantization aware low-rank adaptation (QA-LoRA) adapter, etc. However, it should be noted that the low-rank representations described herein are merely examples of low-rank representations, and are not intended to be limiting.

Turning briefly to FIG. 4B, a flowchart that illustrates an example method for fine-tuning a low-rank representation of a pre-trained GM, according to various implementations, is depicted.

As illustrated in FIG. 4B, the one or more parameters (or alternatively referred to as weights) of a low-rank representation 400 (which may be obtained e.g., based on the operations described in relation to FIG. 4A, or retrieved from one or more low rank representation(s) 136 available locally or remotely) can be updated based on one or more low-rank representation fine-tuning techniques 230. One such technique is supervised fine-tuning (SFT). In SFT, a high-quality dataset including examples of input prompts 410 and corresponding labeled responses 420 can be used. This data can be generated, for instance, using human annotators. The low-rank representation 400 can then be trained using supervised learning to generate corresponding responses from a given input prompt 410. For instance, based on a given input prompt 410, the low-rank representation 400 can be used to generate corresponding generative output. The generative output can then be compared with a corresponding labeled response 420 for the given input prompt 410 (from the dataset) to determine a corresponding training loss. One or more parameters of the low-rank representation 400 can then be updated based on the training loss. In general, it can be assumed that the amount of training data required for SFT is much lower as compared to, for instance, the amount of training data used in pre-training the machine-learned GM 210. Once it is determined that the low-rank representation fine-tuning has been completed, the fine-tuned low-rank representation 430 can be output for further processing and/or stored locally or remotely.

Although it has generally been described that low-rank representations described herein (e.g., low-rank representation(s) 136, low rank representation 400, fine-tuned low-rank representation 430, and reinforcement learned low-rank representation 520) can be used to generate generative output, it will be appreciated that in some implementations, this also involves the machine-learned GM 210. For instance, in some implementations, the generative output can be determined based on (e.g., by combining) the output of the low-rank representation (e.g., BA) and the output of the machine-learned GM 210, or a subset of the parameters thereof (e.g., W0). For instance, for a given input x, the output of the low-rank representation 400 can be determined based on multiplying the input by BA, the output of the machine-learned GM 210 can be determined based on multiplying the input by W0, and the final output h can be determined by summing the outputs coordinate-wise:

$$h = W 0 x + Δ W x = W 0 x + B A x$$

In this way, the low-rank representation can be easily further trained, and can easily be swapped out for other low-rank representations (e.g., even after deployment as a general purpose agent). Additionally, or alternatively, in some implementations, the low-rank representation 400 can be combined with (e.g., added to, injected into, etc.) the machine learned GM 210, and the resulting model can be used for generating the generative input. For instance, this approach can be used after the low-rank representation 400 has been fully trained (e.g., when deploying as a general purpose agent) to reduce or eliminate any inference latency introduced by the use of low-rank representations.

Turning briefly to FIG. 4C, a flowchart that illustrates another example method for fine-tuning a low-rank representation of a pre-trained GM, according to various implementations, is depicted.

As illustrated in FIG. 4C, it can be determined, at various instances, whether the current version (or instance) of the fine-tuned low-rank representation is compatible with reinforcement learning (e.g., using the “decoupled” machine-trained reward model 330). These instances can be based on, for instance, determining that a predetermined time period has elapsed since the previous instance, determining that a predetermined number of training examples have been processed since the previous instance, etc.

Determining, at block 450, whether the current version of the fine-tuned low-rank representation is compatible with reinforcement learning can be determined, for instance, based on determining that training the current version of the fine-tuned low-rank representation using reinforcement learning results in improved performance (also referred to as evaluation data). This can involve relatively small amounts of reinforcement learning (at least relative to the low-rank representation reinforcement learning 240). Additionally, or alternatively, determining whether the current version of the fine-tuned low-rank representation is compatible with reinforcement learning can be determined based on determining that the current version of the fine-tuned low-rank representation achieves at least a threshold level of performance. Additionally, or alternatively, determining whether the current version of the fine-tuned low-rank representation is compatible with reinforcement learning can be determined based on determining that the current version of the fine-tuned low-rank representation is similar to a previous version of the fine-tuned low-rank representation, at least to a threshold extent.

Notably, determining, at block 450, whether the current version of the fine-tuned low-rank representation is compatible with reinforcement learning can be implemented as one or more parallelized processes (e.g., parallelized relative to the supervised fine-tuning described herein, parallelized relative to the reinforcement learning described herein, parallelized relative to other iterations of determining whether other versions of the fine-tuned low-rank representation is compatible with reinforcement learning, etc.). The one or more parallelized processes utilize various approximation techniques described above or other approximation techniques to select an optimal checkpoint of the fine-tuned low-rank representation, such as the current version of the fine-tuned low-rank representation or one or more prior versions of the fine-tuned low-rank representations. This allows multiple versions of the fine-tuned low-rank representation to be compared to determine the optimal checkpoint from, for example, the supervised fine-tuning described herein (e.g., assuming the same evaluation data is utilized to evaluate the multiple versions of the fine-tuned low-rank representation). In various implementations, determining whether the current version of the fine-tuned low-rank representation (or other versions of the fine-tuned low-rank representation) is compatible with reinforcement learning can be implemented in a cost-effective manner (e.g., by using lower priority resources), such that the parallelized training of the fine-tuned low-rank representation is not negatively impacted.

When it is determined that the current version of the fine-tuned low-rank representation is compatible with reinforcement learning, the method can proceed to operation 452. At operation 452, the current version of the fine-tuned low-rank representation can be stored as a version of the low-rank representation that is known to be compatible with reinforcement learning (or in other words, a checkpointed low-rank representation). In some implementations, the current version of the fine-tuned low-rank representation can overwrite a previous version of the fine-tuned low-rank representation known to be compatible with reinforcement learning.

When it is determined that the current version of the fine-tuned low-rank representation is not compatible with reinforcement learning, the method can proceed to operation 454. At operation 454, a previous version of the fine-tuned low-rank representation known to be compatible with reinforcement learning can be retrieved. For instance, the previous version of the fine-tuned low-rank representation known to be compatible with reinforcement learning can be the latest stored version of the fine-tuned low-rank representation known to be compatible with reinforcement learning. The retrieved version of the fine-tuned low-rank representation can then replace the current version of the fine-tuned low-rank representation as the current version of the fine-tuned low-rank representation (e.g., for any further fine-tuning, or for being output as the final version).

Once the current version of the fine-tuned low-rank representation has been stored at operation 452, or replaced with a retrieved version of the low-rank representation which is known to be compatible with reinforcement learning, it can be determined at block 460 whether the fine-tuning should be terminated. This can be based on, for instance, determining whether the current version of the fine-tuned low rank representation meets a threshold evaluation criterion, determining whether a threshold period of time has elapsed since the fine-tuning started, determining whether a threshold number of training examples have been processed since the fine-tuning started, etc. If it is determined that the fine-tuning should be terminated (or in other words, that the fine-tuning has finished), the method can proceed to operation 462. At operation 462, it can be determined that no further fine-tuning of the low-rank representation is to be performed. The final version of the low-rank representation can then be, for instance, provided for subsequent reinforcement learning 240, and/or stored for later use. If it is determined that the fine-tuning should not be terminated, the method can return to operation 230, such that the current version of the fine-tuned low-rank representation can be further fine-tuned 230 until the next interval.

In this way, the compatibility of the fine-tuned low-rank representation with subsequent reinforcement learning can be ensured. In some implementations, the low-rank representation fine-tuning can be performed continually, and determining the compatibility of the low-rank representation can be performed in a parallelized process (e.g., simultaneously). In this way, any additional latency in fine-tuning the low-rank representation can be reduced.

Turning now back to FIG. 2, as further illustrated in FIG. 2 by the low-rank representation reinforcement learning 240 phase, a low-rank representation of the machine learned generative model 210 can be trained using reinforcement learning. This aspect is described in further detail herein, particularly in relation to FIG. 5.

For instance, turning briefly to FIG. 5, a flowchart that illustrates an example method for training a low-rank representation 430 of a pre-trained GM, according to various implementations, is depicted. As illustrated in FIG. 5, the fine-tuned low-rank representation 430 can be further trained using low-rank reinforcement learning 240. The fine-tuned low-rank representation can be obtained based on, for instance, any of the methods described in relation to FIGS. 4A to 4C, and/or retrieved from one or more stored low-rank representation(s) 136 available locally or remotely.

In some implementations, the fine-tuned low-rank representation 430 can be trained using reinforcement learning based upon reward values provided by a trained reward model (e.g., the machine-trained reward model 330). That is, for a given training prompt 510, the fine-tuned low-rank representation 430 can be used to generate an output which can be evaluated using the machine-trained reward model 330. The parameters of the fine-tuned low-rank representation 430 can be updated (or in other words, adjusted, trained, learned, etc.) using a reinforcement learning update rule based upon the reward value provided by the reward model. This update process can steer the parameterization of the fine-tuned low-rank representation 430 towards outputs with high rewards. In some implementations, the fine-tuned low-rank representation 430 may be updated/fine-tuned based on applying an optimization routine to a reinforcement learning objective function. For instance, in some implementations, a reinforcement learning update rule based upon the Proximal Policy Optimization (PPO) algorithm is used, with the fine-tuned low-rank representation 430 acting as the “policy”. It will be appreciated that other suitable reinforcement learning algorithms can be used as deemed appropriate by a person skilled in the art.

Turning now back to FIG. 2, as further illustrated in FIG. 2, a general purpose agent 250 can be provided based on the trained low-rank representation of the machine-learned GM 210.

For instance, in some implementations, the general purpose agent 250 can be determined based on combining the machine-learned generative model 210 with the trained low-rank representation (e.g., by summing the corresponding parameter weights). The general purpose agent 250 can then be provided as a single model.

Additionally, or alternatively, in some implementations, the general purpose agent 250 can be provided by providing both the machine-learned generative model 210 with the trained low-rank representation (e.g., as separate models). As such, as described herein, generating output using the general purpose agent 250 can include combining output from the machine-learned generative model 210 with output of the trained low-rank representation.

In some implementations, further training data can be obtained subsequent to the general purpose agent 250 being deployed. For instance, various training instances including input provided by a user for the general purpose agent 250, responsive content determined based on processing the input using the general purpose agent 250, and feedback data (e.g., based on user interaction data, human evaluation data, etc.) can be collected. The reward model can be further trained based on this further training data. The low-rank representation can then be further trained, using the further trained reward model. An updated general purpose agent can then be deployed, based on the further trained low-rank representation. In this way, the general purpose agent can be continually improved based on real-world usage, and/or adapted based on changing user behavior, in a relatively computationally inexpensive manner.

Turning now to FIG. 6, a flowchart that illustrates an example method 600 for training a low-rank representation of a pre-trained GM, according to various implementations, is depicted. The method 600 may, for instance, correspond to the method described in relation to FIG. 5. For convenience, the operations of the method 600 are described with reference to a system that performs the operations. This system of the method 600 includes one or more processors, memory, and/or other component(s) of computing device(s). Moreover, while operations of the method 600 are shown in a particular order, this is not meant to be limiting. One or more operations may be reordered, omitted, and/or added.

At block 610, the system receives input data. In some implementations, the input data can be generated based on human user input and/or generated based on output of a GM. In some implementations, the input data can be obtained from a training dataset. The input data can be of any type or configuration suitable for processing by a generative model to generate corresponding generative output.

In some implementations, the input data can be directed to an image generation model configured to generate image data from a set of input data. The respective input data includes, for example: one or more input images, e.g., a content image indicating a desired content of a generated image and a style image indicating a desired style of the generated image; an input natural language description of a desired output; and/or a noise vector.

In some implementations, the input data can be directed to a large language model. Each respective set of input data includes an input prompt, i.e., a natural language input, such as a query. The input prompt may, in some examples, be received from a user in the form of typed text. Alternatively, or additionally, the input prompt may, in some examples, be received from a user in the form of a spoken utterance, that may be converted to text using a speech-to-text process.

At block 620, the system generates, using a low-rank representation of a machine-learned GM, a generative output from the input data. The low-rank representation of the GM can be obtained, for instance, according to any of the methods described in relation to FIGS. 2, and 4A to 4C.

For instance, in some implementations, the system generates the low-rank representation of the machine-learned GM based on decomposing the machine-learned generative model (e.g., into one or more lower rank matrices). In some implementations, the low-rank representation of the machine-learned generative model has been fine-tuned based on training data from multiple domains. In some implementations, the low-rank representation of the machine-learned generative model has been fine-tuned using supervised fine-tuning techniques.

In some implementations, the system fine-tunes the low-rank representation of the machine-learned generative model. In some implementations, during the fine-tuning, the system can determine whether the current version of the fine-tuned low-rank representation of the machine-learned generative model is compatible with reinforcement learning using the machine-learned reward model. Responsive to determining that the current version of the fine-tuned low-rank representation of the machine-learned generative model is compatible with reinforcement learning using the machine-learned reward model, the system can store the current version of the fine-tuned low-ranked representation of the machine-learned generative model as a compatible version of the low-rank representation of the machine-learned generative model. Responsive to determining that the current version of the fine-tuned low-rank representation of the machine-learned generative model is not compatible with reinforcement learning using the machine-learned reward model, the system can obtain a previously stored compatible version of the low-rank representation of the machine-learned generative model to replace the current version fine-tuned low-rank representation of the machine-learned generative model for subsequent processing.

At block 630, the system determines, based on a machine-learned reward model, a corresponding reward from the generative output. The machine-learned reward model can be obtained, for instance, according to any one of the methods described in relation to FIGS. 2, 3A, and 3B.

For instance, in some implementations, the machine-learned reward model has been initialized using the machine-learned generative model. In some implementations, the system initializes the reward model based on the machine-learned generative model, obtains a reward model machine-learning training dataset, and trains, based on the reward model machine learning training dataset, the reward model. Obtaining the reward model machine-learning training dataset can involve, for each of one or more sets of input data, generating, using the machine-learned generative model, one or more generative outputs from a given set of input data, obtaining, for each of the one or more generative outputs, one or more feedback signals, and generating, for inclusion in the machine-learning training dataset, a training example including the respective set of input data, at least one of the corresponding generative outputs, and at least one of the one or more feedback signals for each of the at least one corresponding generative outputs included in the training example. The feedback signals can be obtained, for each of the one or more generative outputs, based on providing, for rendering at a user device, the one or more generative outputs, and receiving, based on user input received at the user device, the one of more feedback signals for each of the one or more generative outputs. The feedback signals can, for instance, be indicative of one or more of: a ranking of each of the one or more generative outputs, a score of each of the one or more generative outputs, a thumbs up/thumbs down indication, a length of the generative output, a computer evaluation of the generative output, user interaction data associated with the generative output (e.g., did the user discard the generative output, how long did the user view the generative output, etc.), etc.

At block 640, the system updates, based on the corresponding reward, one or more parameters of the low-rank representation of the machine-learned model. In some implementations, updating, based on the machine-learning dataset, one or more parameters of the low-rank representation of the machine-learned model uses reinforcement learning techniques. In some implementations, the one or more parameters correspond to feed forward network weights of the machine-learned model.

In some implementations, the system can cause the low-rank representation of the machine-learned model to be deployed for utilization in generating responsive content that is responsive to input data received from client devices of users. For instance, the system can deploy the low-rank representation for use as part of a general purpose agent.

Turning now to FIG. 7, a flowchart that illustrates an example method 700 for providing responsive content using a general purpose agent, according to various implementations, is depicted. For convenience, the operations of the method 700 are described with reference to a system that performs the operations. This system of the method 700 includes one or more processors, memory, and/or other component(s) of computing device(s). Moreover, while operations of the method 700 are shown in a particular order, this is not meant to be limiting. One or more operations may be reordered, omitted, and/or added.

At block 710, the system receives input data associated with (e.g., received from) a client device (e.g., as described in relation to user input engine 111 or implied input engine 114 of FIG. 1). The input data can be of any type or configuration suitable for processing by the general purpose agent to generate corresponding generative output.

For instance, in some implementations the input data is directed to an image generation model configured to generate image data from a set of input data. In such implementations. The respective input data includes, for example: one or more input images, e.g., a content image indicating a desired content of a generated image and a style image indicating a desired style of the generated image; an input natural language description of a desired output; and/or a noise vector.

In some implementations the input data is directed to a large language model (LLM). Each respective set of input data includes an input prompt, i.e., a natural language input, such as a query. The input prompt may, in some examples, be received from a user in the form of typed text. Alternatively, or additionally, the input prompt may, in some examples, be received from a user in the form of a spoken utterance, that may be converted to text using a speech-to-text process.

As mentioned, in some implementations the general purpose agent is configured to generate image data from a set of input data. In such implementations, the one or more generative outputs include one or more images. The respective input data includes, for example: one or more input images, e.g., a content image indicating a desired content of a generated image and a style image indicating a desired style of the generated image; an input natural language description of a desired output; and/or a noise vector.

Additionally, or alternatively, in some implementations the general purpose agent can include a large language model. Each respective set of input data includes an input prompt, i.e., a natural language input, such as a query. The input prompt may, in some examples, be received from a user in the form of typed text. Alternatively, or additionally, the input prompt may, in some examples, be received from a user in the form of a spoken utterance, that may be converted to text using a speech-to-text process. The one or more generative outputs include one or more text sequences, e.g., a natural language text sequence that is responsive to the input query.

At block 720, the system generates, using a general purpose agent, responsive content to the input data, wherein the general purpose agent is configured based on a machine-learned generative model and a low-rank representation of the machine-learned generative model. The low-rank representation can be obtained, for instance, based on any of the methods as described in relation to FIGS. 2, 4A to 4C, 5, and 6.

At block 730, the system causes the client device to render the responsive content (e.g., visibly and/or audibly). For instance, the system can transmit data, to the client device, that is operable for causing the client device to render the responsive content. Responsive to receiving the data, the client device can render the responsive content.

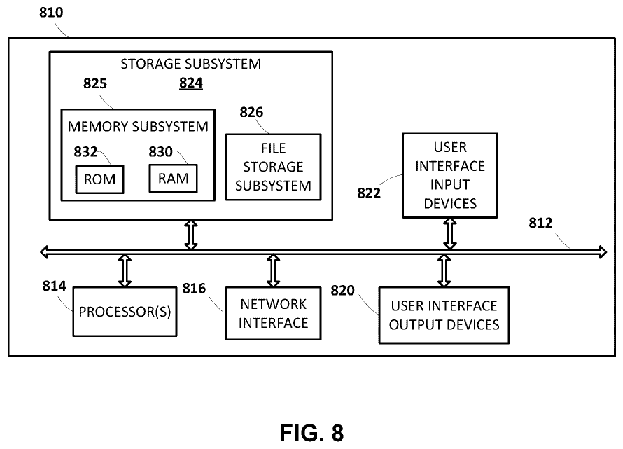

Turning now to FIG. 8, a block diagram of an example computing device 810 that may optionally be utilized to perform one or more aspects of techniques described herein is depicted. In some implementations, one or more of a client device, cloud-based automated assistant component(s), and/or other component(s) may include one or more components of the example computing device 810.

Computing device 810 typically includes at least one processor 814 which communicates with a number of peripheral devices via bus subsystem 812. These peripheral devices may include a storage subsystem 824, including, for example, a memory subsystem 825 and a file storage subsystem 826, user interface output devices 820, user interface input devices 822, and a network interface subsystem 816. The input and output devices allow user interaction with computing device 810. Network interface subsystem 816 provides an interface to outside networks and is coupled to corresponding interface devices in other computing devices.

User interface input devices 822 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 810 or onto a communication network.

User interface output devices 820 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 810 to the user or to another machine or computing device.

Storage subsystem 824 stores programming and data constructs that provide the functionality of some, or all, of the modules described herein. For example, the storage subsystem 824 may include the logic to perform selected aspects of the methods disclosed herein, as well as to implement various components depicted in FIG. 1.

These software modules are generally executed by processor 814 alone or in combination with other processors. Memory 825 used in the storage subsystem 824 can include a number of memories including a main random-access memory (RAM) 830 for storage of instructions and data during program execution and a read only memory (ROM) 832 in which fixed instructions are stored. A file storage subsystem 826 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 826 in the storage subsystem 824, or in other machines accessible by the processor(s) 814.

Bus subsystem 812 provides a mechanism for letting the various components and subsystems of computing device 810 communicate with each other as intended. Although bus subsystem 812 is shown schematically as a single bus, alternative implementations of the bus subsystem 812 may use multiple busses.

Computing device 810 can be of varying types including a workstation, server, computing cluster, blade server, server farm, or any other data processing system or computing device. Due to the ever-changing nature of computers and networks, the description of computing device 810 depicted in FIG. 8 is intended only as a specific example for purposes of illustrating some implementations. Many other configurations of computing device 810 are possible having more or fewer components than the computing device depicted in FIG. 8.

In situations in which the systems described herein collect or otherwise monitor personal information about users, or may make use of personal and/or monitored information), the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

In some implementations, a method implemented by one or more processors is provided, and includes: receiving input data; generating, using a low-rank representation of a machine-learned generative model, a generative output from the input data; determining, based on a machine-learned reward model, a corresponding reward from the generative output, and updating, based on the corresponding reward, one or more parameters of the low-rank representation of the machine-learned model.

These and other implementations of technology disclosed herein can optionally include one or more of the following features.

In some implementations, updating, based on the machine-learning dataset, one or more parameters of the low-rank representation of the machine-learned model can use reinforcement learning techniques.

In some additional or alternative implementations, the one or more parameters may correspond to feed forward network weights of the machine-learned model.

In some additional or alternative implementations, the method can further include generating, based on decomposing the machine-learned generative model, the low-rank representation of the machine-learned generative model.

In some additional or alternative implementations, the low-rank representation of the machine-learned generative model can be fine-tuned based on training data from multiple domains.

In some additional or alternative implementations, the low-rank representation of the machine-learned generative model can be fine-tuned using supervised fine-tuning techniques.

In some additional or alternative implementations, the machine-learned reward model can be initialized using the machine-learned generative model.

In some additional or alternative implementations, the method can further include: initializing the reward model based on the machine-learned generative model; obtaining a reward model machine-learning training dataset; and training, based on the reward model machine learning training dataset, the reward model.

In some additional or alternative implementations, obtaining the reward model machine-learning training dataset can include: for each of one or more sets of input data: generating, using the machine-learned generative model, one or more generative outputs from a given set of input data; obtaining, for each of the one or more generative outputs, one or more feedback signals; and generating, for inclusion in the machine-learning training dataset, a training example including the respective set of input data, at least one of the corresponding generative outputs, and at least one of the one or more feedback signals for each of the at least one corresponding generative outputs included in the training example. In some versions of these implementations, obtaining, for each of the one or more generative outputs, the one or more feedback signals can include: providing, for rendering at a user device, the one or more generative outputs; and receiving, based on user input received at the user device, the one of more feedback signals for each of the one or more generative outputs. In some alternative or additional versions of these implementations, the feedback signals are indicative of one or more of: a ranking of each of the one or more generative outputs, and a score of each of the one or more generative outputs.

In some additional or alternative implementations, the method can further include: fine-tuning the low-rank representation of the machine-learned generative model; determining whether the fine-tuned low-rank representation of the machine-learned generative model is compatible with reinforcement learning using the machine-learned reward model. In some versions of these implementations, the method can further include, responsive to determining that the fine-tuned low-rank representation of the machine-learned generative model is compatible with reinforcement learning using the machine-learned reward model: storing the fine-tuned low-ranked representation of the machine-learned generative model as a compatible version of the low-rank representation of the machine-learned generative model. In some additional or alternative versions of these implementations, the method can further include, responsive to determining that the fine-tuned low-rank representation of the machine-learned generative model is not compatible with reinforcement learning using the machine-learned reward model: obtaining a previously stored compatible version of the low-rank representation of the machine-learned generative model to replace the fine-tuned low-rank representation of the machine-learned generative model for subsequent processing.

In some additional or alternative implementations, the method can further include: causing the low-rank representation of the machine-learned model to be deployed for utilization in generating responsive content that is responsive to input data received from client devices of users.

In some implementations, a method implemented by one or more processors is provided and includes: receiving input data associated with a client device; generating, using a general purpose agent, responsive content to the input data. The general purpose agent can be configured based on a machine-learned generative model and a low-rank representation of the machine-learned generative model, and the low-rank representation of the machine-learned generative model can be trained according to any aspect described herein; and causing the client device to render the responsive content.

These and other implementations of technology disclosed herein can optionally include one or more of the following features.

In some implementations, the machine-learned generative model can be an image generation model, and the responsive content can include an image. In some additional or alternative implementations, the machine-learned generative model can be an LLM, and the responsive content can include one or more text sequences.

In addition, some implementations include one or more processors (e.g., central processing unit(s) (CPU(s)), graphics processing unit(s) (GPU(s), and/or tensor processing unit(s) (TPU(s)) of one or more computing devices, where the one or more processors are operable to execute instructions stored in associated memory, and where the instructions are configured to cause performance of any of the aforementioned methods. Some implementations also include one or more computer readable storage media (e.g., transitory and/or non-transitory) storing computer instructions executable by one or more processors to perform any of the aforementioned methods. Some implementations also include a computer program product including instructions executable by one or more processors to perform any of the aforementioned methods.

What is claimed is:

1. A computer implemented method of training a low-rank representation of a machine-learned model, the method comprising:
receiving input data;
generating, using a low-rank representation of a machine-learned generative model, a generative output from the input data;
determining, based on a machine-learned reward model, a corresponding reward from the generative output, and
updating, based on the corresponding reward, one or more parameters of the low-rank representation of the machine-learned model.

2. The method of claim 1, wherein updating, based on the machine-learning dataset, one or more parameters of the low-rank representation of the machine-learned model uses reinforcement learning techniques.

3. The method of claim 1, wherein the one or more parameters correspond to feed forward network weights of the machine-learned model.

4. The method of claim 1, further comprising:
generating, based on decomposing the machine-learned generative model, the low-rank representation of the machine-learned generative model.

5. The method of claim 1, wherein the low-rank representation of the machine-learned generative model has been fine-tuned based on training data from multiple domains.

6. The method of claim 1, wherein the low-rank representation of the machine-learned generative model has been fine-tuned using supervised fine-tuning techniques.

7. The method of claim 1, wherein the machine-learned reward model has been initialized using the machine-learned generative model.

8. The method of claim 1, further comprising:
initializing the reward model based on the machine-learned generative model;
obtaining a reward model machine-learning training dataset; and
training, based on the reward model machine learning training dataset, the reward model.

9. The method of claim 1, wherein obtaining the reward model machine-learning training dataset comprises:
for each of one or more sets of input data:
generating, using the machine-learned generative model, one or more generative outputs from a given set of input data;
obtaining, for each of the one or more generative outputs, one or more feedback signals; and
generating, for inclusion in the machine-learning training dataset, a training example comprising the respective set of input data, at least one of the corresponding generative outputs, and at least one of the one or more feedback signals for each of the at least one corresponding generative outputs included in the training example.

10. The method of claim 9, wherein obtaining, for each of the one or more generative outputs, the one or more feedback signals comprises:
providing, for rendering at a user device, the one or more generative outputs; and
receiving, based on user input received at the user device, the one of more feedback signals for each of the one or more generative outputs.

11. The method of claim 9, wherein the feedback signals are indicative of one or more of: a ranking of each of the one or more generative outputs, and a score of each of the one or more generative outputs.

12. The method of claim 1, further comprising:
fine-tuning the low-rank representation of the machine-learned generative model;
determining whether the fine-tuned low-rank representation of the machine-learned generative model is compatible with reinforcement learning using the machine-learned reward model; and
responsive to determining that the fine-tuned low-rank representation of the machine-learned generative model is compatible with reinforcement learning using the machine-learned reward model:
storing the fine-tuned low-ranked representation of the machine-learned generative model as a compatible version of the low-rank representation of the machine-learned generative model.

13. The method of claim 12, further comprising:
responsive to determining that the fine-tuned low-rank representation of the machine-learned generative model is not compatible with reinforcement learning using the machine-learned reward model:
obtaining a previously stored compatible version of the low-rank representation of the machine-learned generative model to replace the fine-tuned low-rank representation of the machine-learned generative model for subsequent processing.

14. The method of claim 1, further comprising:
causing the low-rank representation of the machine-learned model to be deployed for utilization in generating responsive content that is responsive to input data received from client devices of users.

15. A computer implemented method comprising:
receiving input data associated with a client device;
generating, using a general purpose agent, responsive content to the input data, wherein the general purpose agent is configured based on a machine-learned generative model and a low-rank representation of the machine-learned generative model, and wherein the low-rank representation of the machine-learned generative model has been trained using the method of any one of claims 1 to 14; and
causing the client device to render the responsive content.

16. The method of claim 15, wherein the machine-learned generative model is an image generation model, and wherein the responsive content comprises an image.

17. A system comprising:
one or more processors; and
a memory storing computer readable instructions that, when executed by the one or more processors, cause the one or more processors to be operable to:
receive input data;
generate, using a low-rank representation of a machine-learned generative model, a generative output from the input data;
determine, based on a machine-learned reward model, a corresponding reward from the generative output, and
update, based on the corresponding reward, one or more parameters of the low-rank representation of the machine-learned model.

18. The system of claim 17, wherein updating, based on the machine-learning dataset, one or more parameters of the low-rank representation of the machine-learned model uses reinforcement learning techniques.

19. The system of claim 17, wherein the one or more parameters correspond to feed forward network weights of the machine-learned model.

20. The system of claim 17, wherein the one or more processors are further operable to:
generate, based on decomposing the machine-learned generative model, the low-rank representation of the machine-learned generative model.
